(19) United States
(12) Patent Application Publication
(10) Pub. No.: US 2003/0156500 A1
(43) Pub. Date: Aug. 21, 2003

(54) Watch

(76) Inventors: Lisa B. Popowich, Philadelphia, PA (US); Jonathan B. Stein, Philadelphia, PA (US)

Correspondence Address: THOMAS J. DURLING, DRINKER BIDDLE & REATH LLP, One Logan Square, 18th & Cherry Streets, Philadelphia, PA, 19103-6996, US

(21) Appl. No.: 10/371,427

(22) Filed: Feb. 21, 2003

Related U.S. Application Data
(60) Provisional application No. 60/358,672, filed on Feb. 21, 2002.

(51) Int. Cl. G04B 37/00

(52) U.S. Cl. 368/316

(57) ABSTRACT

A watch includes a case having a body and removable back panel for receiving a timepiece. The watch includes a clamp assembly having a grip member movably engaging support structure secured to the back panel for movement of the grip member between an open clamp position and a closed clamp position. The clamp assembly may include a jaw clip having a clip arm pivotably connected to a pair of trunnion supports. Alternatively, the clamp assembly may include a lanyard clamp housing defining an interior and a piston slidably contained in the housing interior. The piston includes a transverse opening positioned for alignment with opposite openings formed in the housing.

### CROSS-REFERENCE TO RELATED APPLICATION

The present application is related to and claims priority from U.S. Provisional Application Serial No. 60/358,672, filed Feb. 21, 2002, which is incorporated herein by reference in its entirety.

### FIELD OF THE INVENTION

The present invention relates generally to watches. More particularly the present invention relates to watches adapted for attachment to a user's clothing.

### BACKGROUND OF THE INVENTION

It is well known for a person to carry a watch, a small timepiece constructed to be carried on the person. Watches are traditionally carried either in a pocket, and attached to the user's clothing by a chain, or on a band or bracelet received on a user's wrist. Both of these known arrangements are unsatisfactory if the user cannot use a hand to remove a pocket watch from a pocket or to uncover a wrist watch covered by clothing.

There is a need for a watch that a user can attach to the exterior of his or her clothing, or wearable equipment (e.g. a stethoscope), so that it is readily accessible at all times.

### SUMMARY OF THE INVENTION

According to one embodiment of the present invention, a watch includes a timepiece and a case receiving at least a portion of the timepiece such that a time-indicating portion of the timepiece is presented on a first side of the case. The watch further includes a clamp assembly having a grip member movably engaging grip member support structure secured to a clamp-mounting portion of the case within an outer perimeter defined by the clamp-mounting portion. The watch further includes a biasing member engaging the grip member to urge the grip member towards a closed clamp position. The case preferably includes a back panel removably secured to the clamp assembly.

The clamping assembly may include a jaw clip arm pivotably connected to a pivot pin extending between trunnion supports secured to the back panel of the case. The jaw clip preferably includes ridges adjacent an end of the clip arm for contact with ridges formed on the back panel when the clip arm is pivoted to the closed clamp position.

According to another embodiment of the invention, a watch includes a case adapted for receiving at least a portion of a timepiece and a lanyard holder secured to the case. The lanyard holder includes a wall extending from the case and has at least one opening adapted to receive an elongated lanyard for extension of the lanyard through the wall. The opening in the lanyard holder wall is adapted to permit longitudinal adjustment in the position of the watch along a length of the lanyard while preventing lateral removal of the lanyard from the holder.

The wall of the lanyard holder may define an interior and include a pair of aligned openings on opposite sides thereof. A piston slidably contained within the interior includes an opening alignable with the pair of openings in the cylindrical wall to permit extension of the lanyard through the piston and the cylindrical wall.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a front elevation view of a watch according to the present invention;

FIG. 2 is a right side elevation view of the watch of FIG. 1 with a clamp in a closed position;

FIG. 3 is an exploded view of the watch of the watch of FIG. 1;

FIG. 4 is a rear elevation view of the back panel shown in FIG. 3 with a rocker member of the clamp removed;

FIG. 5 is a sectional view taken along line 5-5 in FIG. 4;

FIG. 6 is a sectional view taken along line 6-6 in FIG. 4;

FIG. 7 is a front elevation view of the rocker arm of the back panel shown in FIG. 3;

FIG. 8 is a section view taken along line 8-8 in FIG. 7;

FIG. 9 is a section view taken along line 9-9 in FIG. 7;

FIG. 10 is a right side elevation view of a watch according to a second embodiment of the invention having lanyard clamp; and

FIG. 11 is a right side elevation view of a watch according to a third embodiment of the invention having a lanyard attachment member.

### DESCRIPTION OF THE PREFERRED EMBODIMENTS

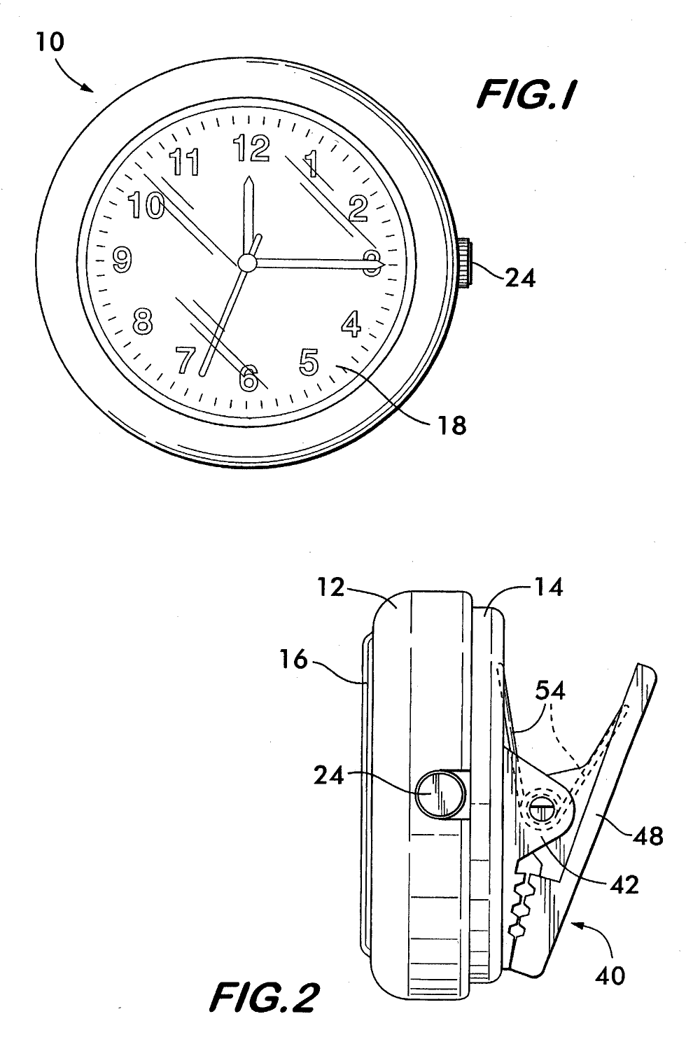

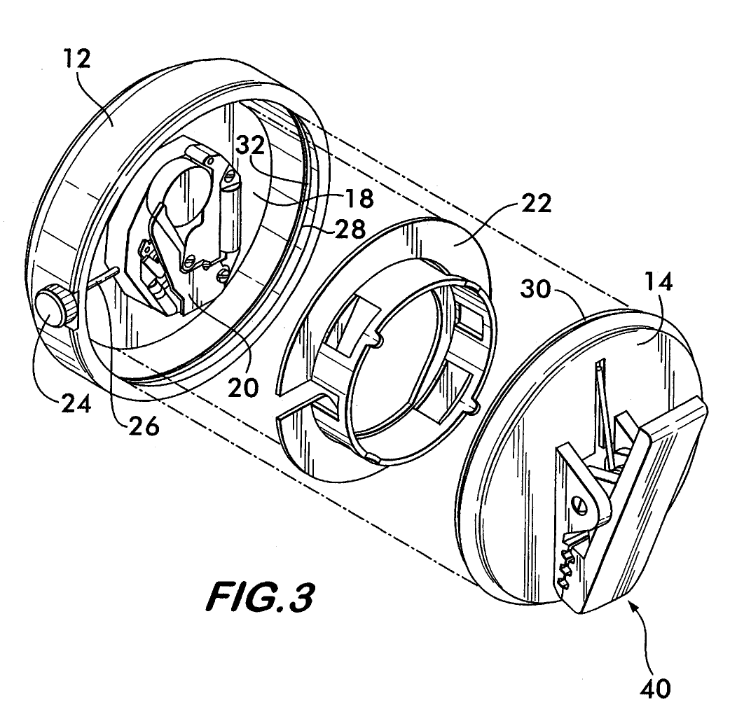

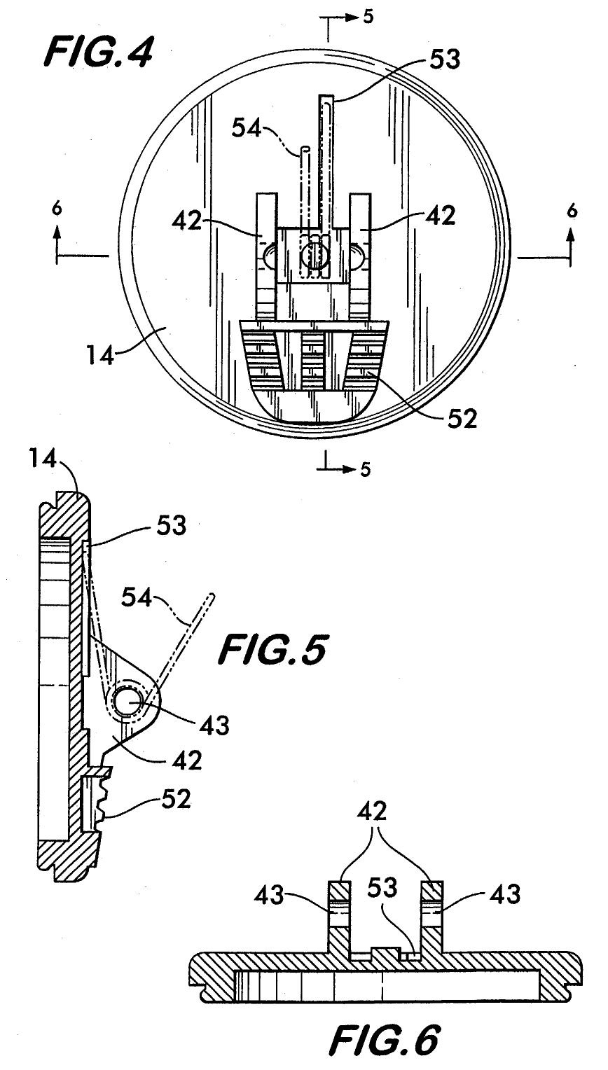

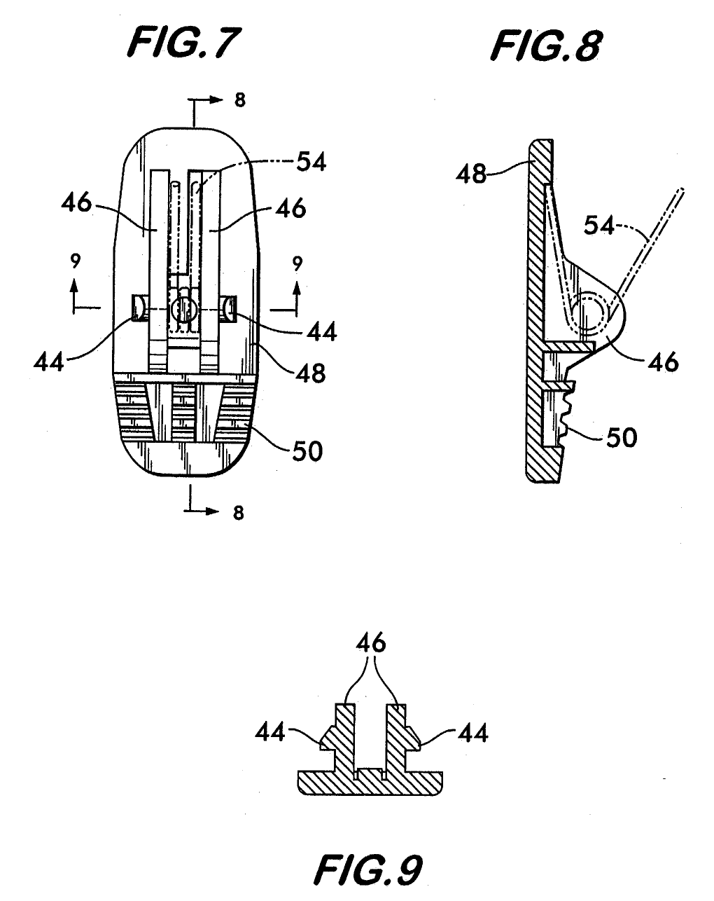

Referring to the drawings, where like numerals identify like elements, and initially to FIGS. 1 to 9, there is shown a watch 10 according to a first embodiment of the present invention. The watch 10 includes a case 12 with a removable back panel 14. The front of the case 12 is formed largely by a transparent cover 16, behind which is a dial 18. A movement 20 is located within the case 12, and mounted to the back of the dial 18. The movement 20 operates the hands of the dial 18. When the back panel 14 is in place, the movement 20 is held in position by a spacer ring 22 between the back panel and the back of the dial 18. A setting knob or crown 24 is attached to the end of a spindle 26 that extends from the movement 20 through one side of the case 12. The back panel 14 is secured to the case 12 by an inwardly projecting lip 28 on the case snapping over an outwardly projecting lip 30 on the back panel. The case may be sealed by an O-ring 32 fitted in the groove under one of the lips 28 and 30.

In accordance with the present invention, a clamp indicated generally by the reference numeral 40 is mounted on the back panel 14. As may be seen in FIGS. 1 to 3, the clamp 40 is generally in the form of an alligator clip. The clamp 40 includes a pair of trunnion supports 42 projecting from the back panel 14. Each of the trunnion supports 42 has a pivot hole 43, which receives a stub pivot pin 44 projecting from one of a further pair of trunnion supports 46 attached to a rocker arm 48. The stub pivot pins 44 and the trunnion supports 42 are provided with ramp surfaces so that they can be snapped together. The back panel 14 carrying the trunnion supports 42 is so oriented that the pivot pin 44 extends horizontally with respect to the watch, that is to say, parallel to the 3-o'clock-to-9-o'clock direction of the dial 18.

The bottom or 6-o'clock end of the rocker arm 48 forms one jaw of the alligator clip, and is provided with transverse ridges or teeth 50 on the side facing the back panel 14. The back panel 14 is provided with similar teeth or ridges 52 facing those on the rocker arm 48, and forms the other jaw. A spring 54 biases the rocker arm in a direction to press the teeth 50 and 52 together, gripping anything inserted between them, such as an edge of the user's clothing. The spring 54 ends rest in channel 53 of the back panel 14 and channel 55 of the rocker arm 48. The teeth can be opened by squeezing the top or 12-o'clock end of the rocker arm 48 towards the case 12, thus enabling the watch to be clipped on or removed. The watch 10 may thus be easily, securely, and easily removably attached to, for example, a hem, lapel, cuff, pocket edge, or other exposed part of the user's apparel.

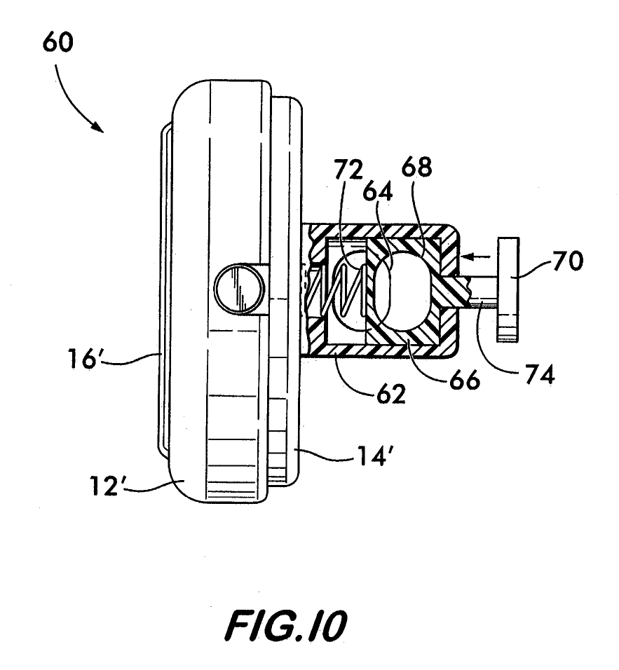

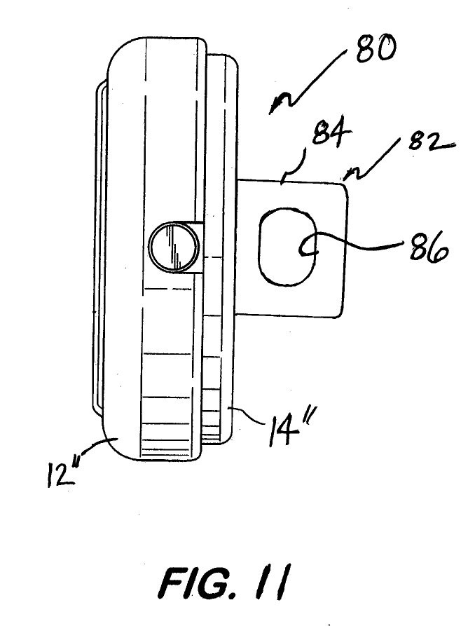

Referring now to FIG. 10, an alternative form of the back panel 14′ has a clamp in the form of a lanyard clip indicated generally by the reference numeral 60 instead of the alligator clip 40. The lanyard clip 60 includes a housing 62 defining a cylindrical internal cavity and having two openings 64 opposite one another in the side walls. Within the cavity is a piston 66 that defines a transverse opening 68. The top of the housing 62 is closed to retain the piston 66 captive, but has an opening through which projects a piston rod 74 with a push-button 70 on the end. The piston 66 is urged upwards, that is to say, in the direction in which the piston rod 74 and push button 70 project furthest from the housing 62, by a spring 72, and can be moved in the opposite direction by pressing in the push button 70. The whole is so arranged that, when the push button 70 is pressed fully in, the three openings 64, 68, and 64 align, enabling a lanyard or cord to be passed through. When the push button 70 is released, the spring 72 displaces the piston, and thus the middle opening 68, so that the lanyard is trapped between the edges of the openings, securing the clamp 60, and thus the watch 10, to the lanyard. This form of clamp is especially suitable for attaching the watch to, for example, the drawstrings of weatherproof outer garments that would cover a conventional wrist or pocket watch inaccessibly.

Referring to FIG. 11, there is shown a watch 80 according to the present invention including a case 12′ and a back panel 14′ secured to the case 12′. The watch includes a lanyard holder 82 having a wall 84 extending from the back panel 14′. The lanyard holder 82 includes an opening 86 in the wall 84 adapted for receiving an elongated member, a lanyard for example, such that the elongated member extends through the lanyard holder. The engagement between the lanyard holder 82 and the elongated member received thereby permits longitudinal adjustment in the position of the watch 80 along a length of the elongated member while preventing lateral removal of the elongated member similar to the engagement between a bolo tie and a bolo tie holder.

Various modifications may be made to the watch described above without departing from the spirit and scope of the present invention. For example, the dial 18 may be replaced by a digital display. If a dial is used, the movement may be either a mechanical or an electronic movement.

The snap-on back panel 14 may be replaced by some other form of mounting, although it is preferred not to use a screw-threaded back panel because of the difficulty of ensuring that the clamp 40 is correctly oriented when the back panel is secure. This could be obviated by a structure in which the front, rather than the back, of the case is the removable panel that affords access to the movement. On the other hand, the clamp 40 may be oriented in a direction other than that shown and described above, or the clamp 40 or the back panel 14 may be mounted so that the clamp is rotatable by the user relative to the orientation of the face 18.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A watch comprising:
a timepiece having a time-indicating portion;
a case having opposite first and second sides, at least a portion of the timepiece received by the case such that the time-indicating portion is presented on the first side, the case further including a clamp mounting portion located on the second side and defining an outer perimeter; and
a clamp assembly including a grip member and grip member support structure, the grip member support structure secured to the clamp mounting portion of the case, the grip member movably engaging the grip member support structure within the outer perimeter of the clamp mounting portion for movement of the grip member between an open clamp position and a closed clamp position,
the clamp assembly further including a biasing member engaging the grip member to urge the grip member towards the closed clamp position.

2. The watch according to claim 1, wherein the case includes a body and a back panel removably secured to the body and wherein the clamp mounting portion of the case is defined by the back panel.

3. The watch according to claim 2, wherein the grip member support structure includes a pair of trunnion supports extending from the back panel and a pivot pin received by an opening in each of the trunnion supports, and wherein the grip support member includes a rocker member pivotably connected to the pivot pin.

4. The watch according to claim 3, wherein the biasing member includes a spring having opposite ends engaging the rocker member and the back panel.

5. The watch according to claim 4, wherein the ends of the spring are received in channels formed in the back panel and the rocker arm.

6. The watch according to claim 3, wherein the rocker arm includes teeth adjacent an end of the rocker arm and wherein the back panel of the case includes teeth positioned to contact the teeth of the rocker arm.

7. The watch according to claim 2, wherein the back panel of the case includes a outwardly projecting lip adapted for attachment to an inwardly projecting lip formed on the body of the case.

8. The watch according to claim 1, wherein the grip support structure includes a housing defining an interior secured to the clamp mounting portion of the case and wherein the grip member includes a piston slidably received within the housing interior.

9. The watch according to claim 8, wherein the housing includes aligned openings on opposite sides of the housing communicating with the interior and wherein the piston includes a transverse opening positioned on the piston for alignment with the housing openings when the grip member is moved to the open clamp position.

10. The watch according to claim 9, wherein the biasing member includes a spring positioned within the housing interior and engaging the piston and the case.

11. The watch according to claim 8, wherein the piston includes a body and a rod secured to the body and wherein the housing includes an end wall opposite the case for capture of the piston body within the housing interior, the housing including an opening in the end wall for extension of the piston rod therethrough.

12. The watch according to claim 11, wherein the piston further includes a button secured to an end of the piston rod opposite the piston body.

13. A watch comprising:
a case including a body defining an interior for receipt of at least a portion of a timepiece and a back panel removably secured to the case body; and
a jaw clip assembly including a pair of trunnion supports extending from the back panel of the clip and having aligned openings, the jaw clip assembly further including a pivot pin extending between the trunnion supports and received by the openings therein, the jaw clip assembly further including a clip arm pivotably secured to the pin for pivoting of the clip arm between an open position and a closed position in which the clip arm contacts the back panel adjacent an end of the clip.

14. The watch according to claim 13, wherein the clip arm includes ridges adjacent the end of the clip arm and wherein the back panel includes ridges positioned for contact with the ridges of the clip arm when the clip arm is pivoted to the closed position.

15. The watch according to claim 13, wherein the jaw clip assembly includes a spring having opposite ends respectively engaging the clip arm and the back panel to urge the clip arm to the closed position, and wherein the back panel and the clip arm include channels for receiving the ends of the spring.

16. A watch comprising:
a case adapted for receiving at least a portion of a timepiece; and
a lanyard holder secured to the case, the lanyard holder including a wall extending from the case and including at least one opening adapted to receive an elongated lanyard for extension of the lanyard through the wall, the at least one opening in the lanyard holder wall adapted to permit longitudinal adjustment in the position of the watch along a length of the lanyard while preventing lateral removal of the lanyard from the holder.

17. The watch according to claim 16, wherein the wall of the lanyard holder is cylindrical and defines a hollow interior, the cylindrical wall including a pair of aligned openings on opposite sides thereof, and wherein the lanyard holder further includes a piston slidably contained within the hollow interior, the piston including an opening alignable with the pair of openings in the cylindrical wall to permit extension of the lanyard through the piston and the cylindrical wall.

18. The watch according to claim 17, wherein the piston includes a body and a rod secured to an end of the body, and wherein the lanyard holder further includes an end wall secured to the cylindrical wall opposite the casing, the end wall having an opening permitting extension of the piston rod through the end wall.
